(19) United States
(12) Patent Application Publication
(10) Pub. No.: US 2009/0260067 A1
(43) Pub. Date: Oct. 15, 2009

(54) Method and system for legitimate lending and sharing of digital copyrighted content items over a data network

(75) Inventor: Amram Racabi, Neve Ziv (IL)

Correspondence Address: THE NATH LAW GROUP, 112 South West Street, Alexandria, VA, 22314, US

(73) Assignee: Hyrax Media Ltd, Kibutz Sa'ar (IL)

(21) Appl. No.: 12/081,391

(22) Filed: Apr. 15, 2008

(51) Int. Cl. H04L 9/32; G06Q 30/00; G06Q 20/00

(52) U.S. Cl. 726/7; 705/26

(57) ABSTRACT

The present invention relates to a method of enabling concurrently lending at least one digital copyrighted content item from one user's terminal to a certain number of other users' terminals over a data network, according to a number of copyright users' licenses of each of said at least one digital copyrighted content item, said method comprises: (a) indexing at least one digital copyrighted content item provided from at least one user's terminal over a data network, giving rise to an items index; (b) receiving a request to lend a digital copyrighted content item to user's terminal over said data network; (c) conducting a search for the requested digital copyrighted content item by means of said items index; (d) if said requested digital copyrighted content item is found by means of said items index, checking whether it is available for lending to said user's terminal, according to a number of available copyright users' licenses of said requested digital copyrighted content item; (e) if said requested digital copyrighted content item is available for lending, then enabling lending it to said user's terminal; and (f) upon receiving another request to lend said digital copyrighted content item, repeating steps ‘d’ and ‘e’, and enabling concurrently lending said copyrighted content item to a certain number of users' terminals until said certain number does not exceed said number of available copyright users' licenses of said digital copyrighted content item.

### FIELD OF THE INVENTION

The present invention relates to digital data sharing. More particularly, the present invention relates to a method and system for legitimate copyrighted data lending and sharing over a data network, such as the Internet.

### DEFINITIONS, ACRONYMS AND ABBREVIATIONS

Throughout this specification, the following definitions are employed:

Peer-To-Peer Network (or P2P): is a computer network, in which each workstation has equivalent capabilities and responsibilities. This differs from client/server conventional networks, in which some computers are dedicated to serving others. P2P networks are used for many purposes, such as sharing data files containing audio, video and any other types of content in a digital format.

### BACKGROUND OF THE INVENTION

In the last decade, the WWW (World Wide Web) has expanded dramatically. More and more people around the world connect to the Internet, becoming a part of the worldwide computer network. By connecting to the Internet, users have access to vast amounts of information, which they can use for their needs. For example, instead of going to a music store, an Internet user can surf to a music-related Web site and download his favorite song. If the song is copyrighted, then for downloading such a song, the user can be invited to pay some predefined sum of money. However, many digital copyrighted data files containing songs, video films, photos, digital books, etc. are shared among Internet users for free, violating the copyright law and leading to a significant decrease in monetary income for copyright owners.

Nowadays, the Internet contains a plurality of data sharing networks, such as P2P (Peer-to-Peer) networks (e.g., Gnutella®, Napster®, KaZaA®, BitTorrent®, eDonkey® and the like), which enables Internet users to share data files stored on their computers. Most of this digital shared data is illegal, such as illegal copies of songs, video films, photos, etc. that infringe copyrights of their legitimate owners. Usually, each P2P user can share digital files with many other P2P users, thus such digital copyrighted files can be spread among P2P users in a very fast manner.

The problem of copyright protection has been recognized in the Prior Art, and various systems have been developed to provide a solution. According to the prior art, for example, WO 02/099716 discloses a system and method for controlling access to digital content, including streaming media. The system includes a Web server, media server and end user processor, such as a personal computer, coupled to a network. The Web server cryptographically generates a ticket in response to an end user's request for access to a file. The ticket is based, at least in part, on a time at or close to a time when the ticket is generated. The media server generates an authorization ticket, preferably using the same cryptographic algorithm as the Web server. The media server authorization ticket is based, at least in part, on a time at or close to a time when the media server receives the request for access to the file. The media server determines whether to grant access to the file by comparing the ticket, as generated by the Web server, to the ticket, as generated by the media server.

U.S. Pat. No. 7,299,498 presents a system and method of sharing digital literary works while protecting against an illegal reproduction through a communication network. The system comprises a data communication network, a list providing server, at least one agent server, at least one user terminal, a main server, at least one sub-server, a premise communication network, and a network interface unit. The system enables users to share digital literary works produced for publicity, works having low quality, or encrypted digital literary works through the network against a distribution of illegally reproduced digital literary works having the same quality as original literary works through a Sharing Web.

U.S. Pat. No. 6,324,650 discloses methods and systems for controlling the disclosure of sensitive information. Disclosure is controlled in the sense that (a) the information is not disclosed until predefined conditions are met, such as the passage of a certain time without an authorized update request for secrecy, (b) copies of the information are protected by encryption and by widespread, unpredictable storage, so that at least one copy will be available when disclosure is required, (c) the information is kept secret until disclosure is required, and (d) when disclosure is required, the information is sent to predefined destinations such as email addresses or posted to Web sites, in a predefined format.

JP 2004334521 teaches providing an access control system for preventing an unauthorized access from a client information processing device to a file stored within a server information processing device, both connected to the network. Access to the file, according to a user's request, is allowed only if the client permits it.

The present invention has many advantages over the prior art. For example, the present invention enables lending digital copyrighted content items (e.g., files) over a data network (such as the Internet, cellular network, etc.) from one user connected to said data network to another, without infringing the copyrights, and protecting the lent copyrighted files from illegal reproduction.

Another advantage of the present invention is providing a method and system that enables lending digital copyrighted content items over a data network between various users' terminals, such as personal computers, laptops, mobile devices (cellular phones, PDAs (Personal Digital Assistants), etc.) and the like.

Still another advantage of the present invention is providing a method and system that enables concurrent lending of digital copyrighted content items to a certain number of users over a data network, according to a number of legitimate users' licenses of said content items.

Still another advantage of the present invention is providing a method and system that enables lending digital copyrighted content items substantially in real-time.

A further advantage of the present invention is providing a method and system that enables lending digital copyrighted content items over a data network, wherein the terminal of a user that lends said copyrighted content items can stay off-line, if said copyrighted content items have been previously lent over said data network.

Still a further advantage of the present invention is providing a method and system for lending digital copyrighted content items over a data network, which is user friendly.

Other advantages of the present invention will become apparent as the description proceeds.

### SUMMARY OF THE INVENTION

The present invention relates to a method and system for legitimate copyrighted data lending and sharing over a data network, such as the Internet.

The method of enabling concurrently lending at least one digital copyrighted content item from one user's terminal to a certain number of other users' terminals over a data network, according to a number of copyright users' licenses of each of said at least one digital copyrighted content item, said method comprises:
a) indexing at least one digital copyrighted content item provided from at least one user's terminal over a data network, giving rise to an items index;
b) receiving a request to lend a digital copyrighted content item to user's terminal over said data network;
c) conducting a search for the requested digital copyrighted content item by means of said items index;
d) if said requested digital copyrighted content item is found by means of said items index, checking whether it is available for lending to said user's terminal, according to a number of available copyright users' licenses of said requested digital copyrighted content item;
e) if said requested digital copyrighted content item is available for lending, then enabling lending it to said user's terminal; and
f) upon receiving another request to lend said digital copyrighted content item, repeating steps ‘d’ and ‘e’, and enabling concurrently lending said copyrighted content item to a certain number of users' terminals until said certain number does not exceed said number of available copyright users' licenses of said digital copyrighted content item.

The method of enabling concurrently lending at least one digital copyrighted content item from a server to a certain number of users' terminals over a data network, according to a number of copyright users' licenses of each of said at least one digital copyrighted content item, said method comprises:
a) storing at least one digital copyrighted content item and its corresponding index within a server, giving rise to an items index;
b) receiving a request to lend a digital copyrighted content item to user's terminal over said data network;
c) conducting a search for the requested digital copyrighted content item by means of said items index;
d) if said requested digital copyrighted content item is found by means of said items index, checking whether it is available for lending to said user's terminal, according to a number of available copyright users' licenses of said requested digital copyrighted content item;
e) if said requested digital copyrighted content item is available for lending, then enabling lending it from said server to said user's terminal; and
f) upon receiving another request to lend said digital copyrighted content item, repeating steps ‘d’ and ‘e’, and enabling concurrently lending said copyrighted content item to a certain number of users' terminals until said certain number does not exceed said number of available copyright users' licenses of said digital copyrighted content item.

According to an embodiment of the present invention, the method further comprises conveying a software component to user's terminal for indexing the at least one copyrighted content item to be lent from said user's terminal.

According to another embodiment of the present invention, the method further comprises comparing a number of lent digital copyrighted content items with a number of overall copyright users' licenses of said digital copyrighted content item for determining whether said digital copyrighted content item is available for lending.

According to a particular embodiment of the present invention, the method further comprises indicating the number of overall or available copyright users' licenses within the items index.

According to another particular embodiment of the present invention, the method further comprises indicating the metadata of each content item within the items index.

According to an embodiment of the present invention, the method further comprises providing a server within the data network for interconnecting users' terminals over said data network and enabling concurrent lending of the at least one digital copyrighted content item from one user's terminal, from which it is provided, to the certain number of other users' terminals, according to a number of legitimate copyright users' licenses of said digital copyrighted content item.

According to another embodiment of the present invention, the method further comprises conveying the items index from the at least one user's terminal to the server.

According to still another embodiment of the present invention, the method further comprises surfing to a predetermined Web site for searching for the particular copyrighted content item.

According to still another embodiment of the present invention, the method further comprises streaming the copyrighted content item from the at least one user's terminal.

According to still another embodiment of the present invention, the method further comprises configuring the server with at least one of the following:
a) a web server for hosting at least one web site, and for enabling users' terminals to connect to said at least one web site;
b) a data streaming server for enabling streaming the at least one digital copyrighted content item to the certain number of other users' terminals; and
c) a storage server for storing the at least one digital copyrighted content item and/or its corresponding index, said at least one digital copyrighted content item to be lent to said certain number of other users' terminals.

According to a further embodiment of the present invention, the method further comprises controlling lending the requested digital copyrighted content item by means of the server.

According to still a further embodiment of the present invention, the method further comprises controlling lending the requested digital copyrighted content item by means of the software component.

According to still a further embodiment of the present invention, the method further comprises streaming the digital copyrighted content item substantially in real-time.

According to still a further embodiment of the present invention, the method further comprises caching the at least one digital copyrighted content item by means of the server.

According to still a further embodiment of the present invention, the method further comprises streaming the cached digital copyrighted content item from the server to the at least one user's terminal.

According to an embodiment of the present invention, the method further comprises uploading the at least one digital copyrighted content item to the server, prior to streaming it to the certain number of users' terminals.

According to another embodiment of the present invention, the method further comprises registering within a Web site for lending or borrowing the at least one copyrighted content item.

According to still another embodiment of the present invention, the method further comprises sending a request for borrowing the at least one copyrighted content item to the at least one user's terminal, by which said copyrighted content item is provided.

According to still another embodiment of the present invention, the method further comprises lending the copyrighted content item for a predefined period of time.

According to still another embodiment of the present invention, the method further comprises disallowing the user that lent the copyrighted content item to access said copyrighted content item until the lending period is over.

According to still another embodiment of the present invention, the method further comprises disallowing the user, to which the copyrighted content item is lent to access said copyrighted content item after the lending period is over.

According to a further embodiment of the present invention, the method further comprises enabling the user that borrows the copyrighted content item to make a payment for borrowing said copyrighted content item.

According to still a further embodiment of the present invention, the method further comprises downloading the copyrighted content item to the terminal of the user, to which it is lent.

The server is capable of enabling concurrently lending a digital copyrighted content item from one user's terminal to a certain number of other users' terminals according a number of legitimate copyright users' licenses of said digital copyrighted content item, said server comprises means configured to:
a) interconnect at least two users' terminals over a data network;
b) obtain an index of at least one digital copyrighted content item provided from at least one of said at least two users' terminals; and
c) enable concurrent lending of the digital copyrighted content item, indicated by means of said index, from said at least one user's terminal to a certain number of other users' terminals over said data network according a number of legitimate copyright users' licenses of said digital copyrighted content item.

The server is capable of enabling concurrently lending a digital copyrighted content item over a data network to a certain number of other users' terminals according a number of legitimate copyright users' licenses of said digital copyrighted content item, said server comprises means configured to:
a) store at least one digital copyrighted content item and its corresponding index, giving rise to an items index; and
b) enable concurrent lending of the digital copyrighted content item, indicated by means of said items index, from said server to a certain number of other users' terminals over said data network according a number of legitimate copyright users' licenses of said digital copyrighted content item.

According to an embodiment of the present invention, the digital copyrighted content item is streamed from one user's terminal to another user's terminal.

According to another embodiment of the present invention, the digital copyrighted content item is streamed from the at least one user's terminal to said server.

According to still another embodiment of the present invention, the digital copyrighted content item is streamed from said server to the user's terminal.

According to a further embodiment of the present invention, the digital copyrighted content item is streamed substantially in real-time.

The system is configured to enable concurrently lending digital copyrighted content items over a data network from one user's terminal to a certain number of other users' terminals according a number of copyright users' licenses of each digital copyrighted content item, said system comprises:
a) at least two users' terminals connected to a data network, wherein at least one of said at least two users' terminals provides a digital copyrighted content item to be lent to at least one another user's terminal; and
b) a server connected to said data network, said server interconnecting said at least two users' terminals and enabling concurrently lending said digital copyrighted content item from said at least one user's terminal to a certain number of other users' terminals according a number of copyright users' licenses of said digital copyrighted content item.

The system is configured to enable concurrently lending digital copyrighted content items over a data network to a certain number of users' terminals according a number of copyright users' licenses of each digital copyrighted content item, said system comprises:
a) at least two users' terminals connected to a data network; and
b) a server connected to said data network, said server storing at least one copyrighted content item and its corresponding index, giving rise to items index, and enabling concurrently lending said digital copyrighted content item to a certain number of users' terminals according a number of copyright users' licenses of said digital copyrighted content item.

The present invention also relates to a program storage device readable by machine, tangibly embodying a program of instructions executable by the machine to perform a method of enabling concurrently lending at least one digital copyrighted content item from one user's terminal to a certain number of other users' terminals over a data network, according to a number of copyright users' licenses of each of said at least one digital copyrighted content item, said method comprises:
a) indexing at least one digital copyrighted content item provided from at least one user's terminal over a data network, giving rise to an items index;
b) receiving a request to lend a digital copyrighted content item to user's terminal over said data network;
c) conducting a search for the requested digital copyrighted content item by means of said items index;
d) if said requested digital copyrighted content item is found by means of said items index, checking whether it is available for lending to said user's terminal, according to a number of available copyright users' licenses of said requested digital copyrighted content item;
e) if said requested digital copyrighted content item is available for lending, then enabling lending it to said user's terminal; and
f) upon receiving another request to lend said digital copyrighted content item, repeating steps ‘d’ and ‘e’, and enabling concurrently lending said copyrighted content item to a certain number of users' terminals until said certain number does not exceed said number of available copyright users' licenses of said digital copyrighted content item.

The present invention further relates to a program storage device readable by machine, tangibly embodying a program of instructions executable by the machine to perform a method of enabling concurrently lending at least one digital copyrighted content item from a server to a certain number of users' terminals over a data network, according to a number of copyright users' licenses of each of said at least one digital copyrighted content item, said method comprises:
a) storing at least one digital copyrighted content item and its corresponding index within a server, giving rise to an items index;
b) receiving a request to lend a digital copyrighted content item to user's terminal over said data network;
c) conducting a search for the requested digital copyrighted content item by means of said items index;
d) if said requested digital copyrighted content item is found by means of said items index, checking whether it is available for lending to said user's terminal, according to a number of available copyright users' licenses of said requested digital copyrighted content item;
e) if said requested digital copyrighted content item is available for lending, then enabling lending it from said server to said user's terminal; and
f) upon receiving another request to lend said digital copyrighted content item, repeating steps ‘d’ and ‘e’, and enabling concurrently lending said copyrighted content item to a certain number of users' terminals until said certain number does not exceed said number of available copyright users' licenses of said digital copyrighted content item.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic block diagram of a system for concurrently lending digital copyrighted content items over a data network (such as the Internet, cellular network, etc.), according to an embodiment of the present invention;

FIG. 2A is a schematic illustration of a server for enabling concurrently lending digital copyrighted content items over a data network, according to an embodiment of the present invention;

FIG. 2B is a schematic illustration of basic characteristics (services) of a software component, according to an embodiment of the present invention;

FIG. 3A is a flow-chart of a method for enabling concurrent lending of digital copyrighted content items over a data network, according to an embodiment of the present invention; and

FIG. 3B is a flow-chart of a method for borrowing digital copyrighted content items over a data network, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PREFERRED EMBODIMENTS

In the following detailed description; numerous specific details are set forth in order to provide a thorough understanding of the invention. However, it will be understood by those skilled in the art that the present invention may be practiced without these specific details. In other instances, well-known methods, systems, procedures, components, circuits and the like have not been described in detail so as not to obscure the present invention.

Hereinafter, whenever the term “lending” is mentioned, it also refers to the term “sharing”, and these both terms are used interchangeably. In addition, whenever the term “content item” or “item” is mentioned, it should be noted that it refers to any digital data, such as a digital file, a portion of a digital file, software code, etc. Also, wherein the term “real-time” is mentioned, it can be interpreted as “substantially real-time”, “near real-time” and the like.

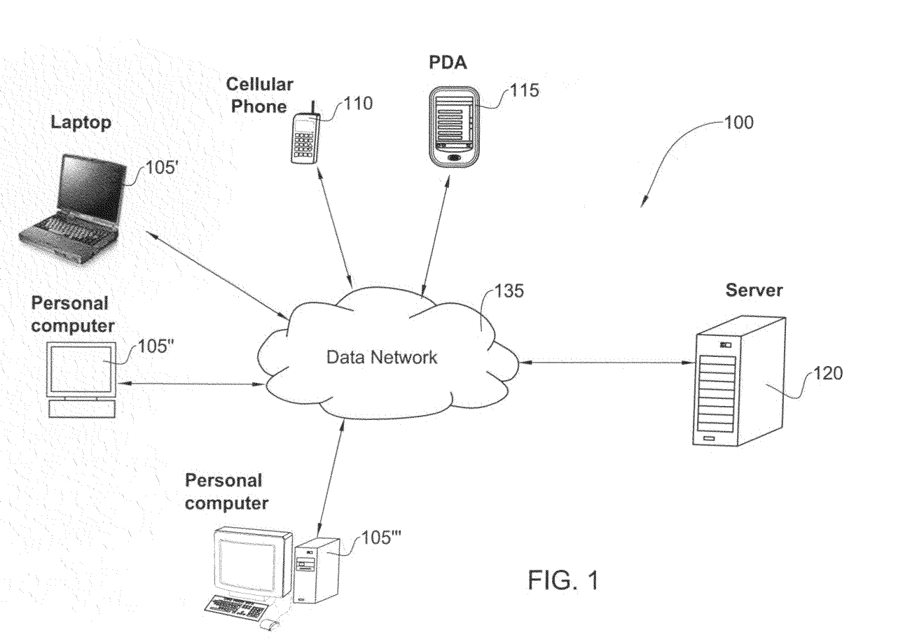

FIG. 1 is a schematic block diagram of a system 100 for concurrently lending digital copyrighted content items over a data network (such as the Internet, cellular network, etc.), according to an embodiment of the present invention. System 100 comprises a plurality of users' terminals, such as personal computers 105′, 105″, 105′″, cellular phone 110, PDA (Personal Digital Assistant) 115 or any other stationary/mobile devices, for lending digital copyrighted content items over data network 135; and a server 120, provided within said data network 135, for interconnecting said plurality of user's terminals and enabling concurrently lending digital copyrighted content items from one user's terminal to a certain number of other users' terminals in accordance with the copyright policy of each of said copyrighted content items. The copyright policy of each copyrighted content item is related to a number of available legitimate (purchased) users' licenses. For example, if one user has purchased a song, then he can lend this song (e.g., as a digital file) to another user. During the time period when the song is lent, the lender is not allowed to listen to the song until the borrower “returns” the rights for the song back to said lender. For that, an access of said lender to the lent song is denied. For another example, a digital copyrighted content item can be a software application that has five users' licenses. In this case, the user that has purchased (or legally obtained) such software program/application can lend it to five users (he can share it with other four users, and/or he can lend his fifth user's license to a fifth user).

According to an embodiment of the present invention, for lending copyrighted content items, a user registers within a predefined Web site over data network 135 (the Web site can be hosted by server 120). Then, the user downloads from said Web site a software component 130 to be installed on his network terminal (e.g., personal computer 105′, cellular phone 110). Software component 130 determines copyrighted content items stored on (or to be provided from) said personal computer 105′, which are authorized by the user to be lent to another one or more users. For this, a user can store such copyrighted content items within a predefined folder that is “recognized” by software component 130 (e.g., a folder named as “Lending/Sharing”). In addition, software component 130 can determine the copyrighting policy for lending such copyrighted content items, according to a number of legally purchased users' licenses. The copyrighting policy of each copyrighted content item can determined, for example, by analyzing the extension of said each copyrighted content item. For example, if the copyrighted content item is a song, then software component 130 can determine this by analyzing its file extension (e.g., “.wav”, “mp3” and the like), and then enables lending the file (content item) to another single user (since, usually, the song is purchased with a single user's license only). During the time period when the song is lent, software component 130 prevents from the lender accessing the lent copyrighted content item. Only when the lending period is over (i.e., the borrower “returns” the rights for the lent song back to the lender), then the lender is allowed to listen to the song.

According to another embodiment of the present invention, the copyright policy of each copyrighted content item to be lent can be stored, for example, within a predefined file (e.g., as a table, list and the like) on each user's terminals and/or within server 120. It should be noted that if software component 130 is unable to determine the copyrighting policy of a copyrighted content item, then the copyrighted content item can be lent, for example, to a single user only (e.g., according to default settings).

According to an embodiment of the present invention, software component 130 of each terminal indexes all digital copyrighted content items, stored within (or to be provided from) said each terminal for lending, and then provides the items index to server 120. In addition, when a new copyrighted content item is uploaded to the terminal, corresponding software component 130 updates the items index of said terminal. The items index of each terminal can be updated, for example, once a day, twice a day, etc. The indexes of copyrighted content items from all users' terminals can be unified, giving rise to an overall items index. Such overall items index can also be stored within server 120. A user, wishing to borrow a copyrighted content item, by registering and logging in a predefined Web site can see, for example, which items can be lent from each terminal. The user can further search by means of said (overall) items index for a specific content item that he wishes to borrow. It should be noted that such a user can be requested to register within said predefined Web site over data network 135 before he borrows one or more copyrighted content items. After registering, the user can be further requested to download software component 130 and install it on his network terminal (e.g., cellular phone 110) to enable borrowing such content items.

It should be noted that each copyrighted content item to be lent can be indexed according to various parameters/metadata, such as a category, genre, name, file extension, lending time period, lending cost, number of legitimate users' licenses, number of available legitimate users' licenses, and the like. Thus, when a user surfs to a predefined Web site for borrowing a copyrighted content item, he is able to search for such content item (by means of items index) within, for example, a corresponding category or genre, to which said copyrighted content item is related.

According to an embodiment of the present invention, software component 130 enables streaming the requested digital copyrighted content item from the lender's terminal (on which said software component 130 is installed) to the borrower's terminal. It should be noted that streaming of the content items can be conducted via server 120. When a user requests to borrow a copyrighted content item, server 120 communicates with a corresponding terminal that stores such an item, and interconnects between the borrower's and lender's terminals. After that, software component 130 installed on the lender's terminal, starts streaming the requested copyrighted content item to the borrower's terminal. The borrower can start using (e.g., listening, watching, playing, reading and the like) the content of the borrowed copyrighted content item substantially in real-time, without the need to download and store it on his terminal. For example, if the borrowed copyrighted content item is a song, then the borrower can start listening to the song in real-time; if the borrowed content item is a video clip, then the borrower can start watching to it in real-time. Further, server 120 can cache the copyrighted content item for later usage. Such content item caching can occur while the item (e.g., a file) is streamed from lender's terminal to the borrower's terminal. According to another embodiment of the present invention, copyrighted content items can be uploaded from users' terminal to server 120, for example, prior to streaming them to one or more user's terminals. Thus, when a user wishes to borrow a copyrighted content item from another user, while said copyrighted content item is already cached (stored) by server 120, then such an item is provided to borrower directly from the cache (memory means) of server 120, and the terminal of the lender can stay offline.

According to an embodiment of the present invention, server 120 controls concurrent lending of a digital copyrighted content item from the lender's terminal (or from the cache of said server 120) to the borrower's terminal, according to a number of available legitimate users' licenses of said copyrighted content item. For that, for example, server 120 determines a number of overall legitimate users' licenses (purchased by the lender) of said copyrighted content item that is stored on (or provided from) said lender's terminal, and compares it with a number of the lent said copyrighted content items (a number of the lent users' licenses of said copyrighted content item). If said number of overall legitimate users' licenses is greater than said number of the lent users' licenses, then one or more users' licenses are still available for lending, and server 120 enables lending of said copyrighted content item accordingly. According to another embodiment of the present invention, software component 130, installed within said lender's terminal, controls concurrent lending of said digital copyrighted content item by performing the above comparison. Thus, the control can be performed either by means of server 120 and/or by means of software component 130 installed on user's terminal, from which the copyrighted item is intended to be lent. According to still another embodiment of the present invention, when said copyrighted content item is lent, it is indicated within a corresponding table (or file), stored on the lender's terminal. Thus, instead of performing the above comparison, server 120 and/or software component accesses said table for determining whether there is one or more available users' licenses.

According to an embodiment of the present invention, when concurrently lending copyrighted content items to other users, a time period for which the users can use (listen, watch, play, read, etc.) the contents of these copyrighted content items can be predefined, such as 5 minutes, 1 hour, 1 day, 1 month and the like. It should be noted that the lending time period can be selected by one or more of the following: the borrower, lender, provider of server 120, provider of software component 130, etc. According to another embodiment of the present invention, the lender can request “returning” the rights for the lent copyrighted content item back to him: for example, he can send a message to the borrower stating that he wishes to start using the content of the lent content item in the next 12 hours. If no response is received from the borrower, then the rights for said copyrighted content item can be automatically “returned” back to the lender. Then, the lender gets access to the content item, and the borrower is prevented from accessing the content item by software component 130 installed on his terminal. According to still another embodiment of the present invention, the copyrighted content item can be lent for an unlimited period of time, for example, when the lender does not need said item anymore. In addition, the copyrighted content item can be lent for a predefined sum of money, according to the lending time period (e.g., $1 per minute, $10 per day, etc.). Further, the lender can set a fixed lending price: for example, $100 for an unlimited period of time. In addition, the lending cost can be set also according to the quality of the copyrighted content item to be lent, the file size of said copyrighted content item and corresponding server 120 storage space (memory means) to be used for caching said copyrighted content item, etc.

It should be noted that according to an embodiment of the present invention, a provider of server 120 and/or of software components 130 can receive royalties from each transaction. For example, if a copyrighted content item is lent for $10, said provider receives 50% of the transaction, i.e. $5. Alternatively, said provider can receive a fixed price per each transaction and/or per each predefined lending time unit (e.g., per a minute). Thus, for example, the system 100 provider can receive $4 per each transaction without considering the overall lending period of time.

It is supposed, for example, that a digital copyrighted content item is a song to be lent to a user, and there is more than one user that wishes to borrow said song. Then, according to an embodiment of the present invention, server 120 (by means of corresponding software installed within it) can automatically ask for permission from the Association (Union) of Authors (to which the author/singer of the song is legally joined) to lend the copyrighted content item to additional users. Then by receiving such permission, additional royalties are paid to said Association of Authors. For example, if the single user's license costs $10, the borrower can pay, for example, $5 to the Association of Authors, $2.5 to the lender and $2.5 to the provider of server 120 (and/or of software components 130). The process of payment to the Association of Authors is transparent to the borrower, and he pays $10 as one payment (the payment can be further split by server 120 between said lender, provider and Association of Authors).

According to an embodiment of the present invention, instead of receiving a payment from a borrower, a user that lends a copyrighted content item can receive “credit points” for each copyrighted content item that he lends. For example, if lending the copyrighted content item costs $10, then the lender can receive 10 credit points, instead of $10 (for example, one “credit point” per $1). After that, he can borrow another copyrighted content item from another user by using the accumulated “credit points”. The “credit points” can be provided to each user according to various parameters, such as lending period of time, type of the copyrighted content item (e.g., song, movie) to be lent, category or genre of said copyrighted content item, number of legitimate users' licenses, the quality of said copyrighted content item, the file size of said copyrighted content item and corresponding server 120 storage space to be used for caching said copyrighted content item, etc.

According to an embodiment of the present invention, software component 130 installed within each user's terminal enables each user to search the overall items index of all copyrighted content items stored on users' terminals (for finding a particular copyrighted content item that he wishes to borrow) without the need to surf to a dedicated Web site. For conducting such a search, software component 130 can provide a corresponding User Interface on the terminal of said each user.

According to a further embodiment of the present invention, if more than one user's terminal stores a copyrighted content item, which is requested to be borrowed by another user, than one or more parameters are analyzed for determining from which user to borrow said item. For example, such parameters can be: the bandwidth of each user's network connection; a type of a lending terminal (e.g., laptop, mobile device, personal computer, etc.); reliability of each user (that can be, for example, determined statistically, based on the lending history of each user); geographic proximity between the user that lends the content item and the user that borrows said content item; an amount of payment that is requested by users for lending/borrowing copyrighted content items; etc.

It should be noted that according to an embodiment of the present invention, the copyrighted content item can be any digital content item related to any content, such as a song, video film, photo, picture, audio, game, software application, or any other.

In addition, it should be noted that according to an embodiment of the present invention, software component 130 is installed on users' terminals that lend copyrighted content items, and users that borrow said copyrighted content items are not required to install such software component 130 on their corresponding terminals. According to another embodiment of the present invention, users that borrow copyrighted content items are also required to install such software component 130 on their terminals (e.g., on cellular phones 110). Installed software components 130 provide to users appropriate User Interfaces for borrowing/lending copyrighted content items.

Further, it should be noted that according to an embodiment of the present invention, data network 130 can be any network, such as the Internet, wireless, wired, cellular, satellite, LAN (Local Area Network), Extranet, P2P or any other network.

According to an embodiment of the present invention, copyrighted content items are stored within server 120 with their corresponding index (items index). Such copyrighted content items (and their corresponding index) can be stored within said server 120 by means a provider of said server 120, for example. According to this embodiment, the copyrighted content items are concurrently lent to users directly from said server 120.

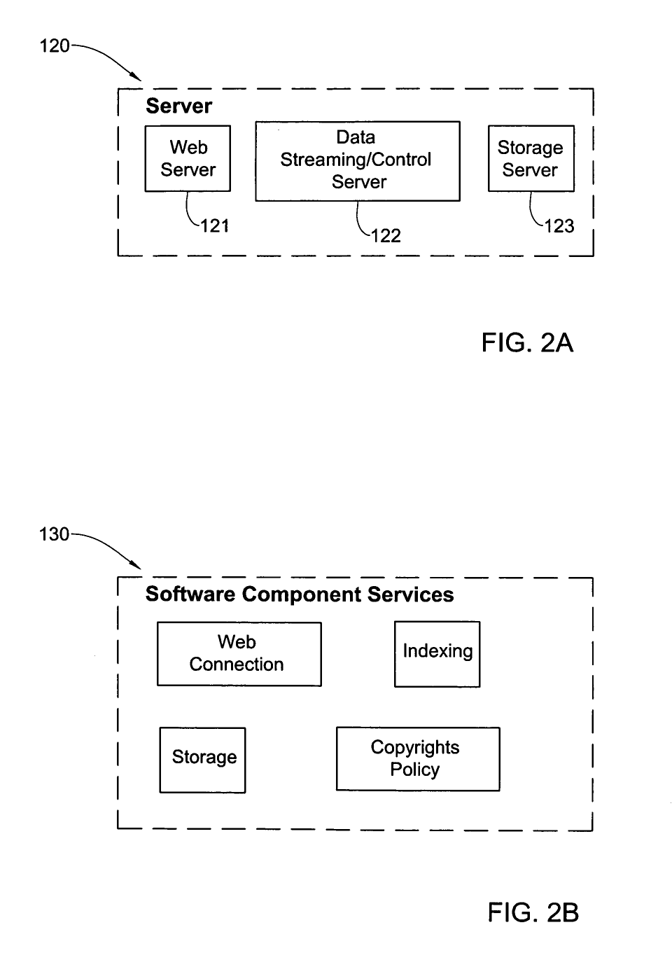

FIG. 2A is a schematic illustration of server 120 for enabling concurrently lending digital copyrighted content items over data network 135, according to an embodiment of the present invention. Server 120 is configured to have the functionality (and corresponding hardware/software) of one or more of the following: Web server 121 for hosting a Web site, by means of which users can concurrently lend/borrow digital copyrighted content items (songs, video films, photos, pictures, games, software applications, etc.); Data Streaming/Control server 122 for enabling concurrently lending digital copyrighted content items from the lender's terminal (or from the cache of server 120) to the borrower's terminal by streaming said digital copyrighted content items to said borrower's terminal, according to a number of available legitimate users' licenses of each of said digital copyrighted content items; and Storage server 123 for caching the streamed digital copyrighted content items and storing them for later usage.

According to another embodiment of the present invention, software component 130 installed on lender's terminal enables streaming the requested digital copyrighted content item from said lender's terminal to the borrower's terminal via server 120 (via Streaming/Control server 122). When a user requests to borrow a copyrighted content item, server 120 communicates with a corresponding terminal that stores such an item, and interconnects between the borrower's and lender's terminals. After that, software component 130 installed on the lender's terminal, starts streaming the requested copyrighted content item to the borrower's terminal. The borrower can start using (e.g., listening, watching, playing, reading and the like) the content of the borrowed copyrighted content item in real-time, without the need to store it on his terminal. For example, if the borrowed copyrighted content item is a song, then the borrower can start listening to the song substantially in real-time; if the borrowed content item is a video clip, then the borrower can start watching to it substantially in real-time. Further, the copyrighted content item can be cached and stored within Storage server 123 for later usage. Such caching can occur while the content item (e.g., a file) is streamed from lender's terminal to borrower's terminal. According to another embodiment of the present invention, copyrighted content items can be uploaded from users' terminal to Storage server 123, for example, prior to streaming them to one or more user's terminals. Thus, when a user wishes to borrow a copyrighted content item from another user, while said copyrighted content item is already cached (stored) by Storage server 123, then such an item is provided to the borrower directly from the cache of Storage server 123, and the terminal of the lender can stay offline. According to still another embodiment of the present invention, the user that wishes to lend or share one or more copyrighted content items to other users, can upload such content items to server 120 by means of his terminal (e.g., personal computer 105′). After uploading them, his terminal can stay offline, and is not required to be connected to data network 135 for lending or sharing said copyrighted content items.

According to an embodiment of the present invention, server 120 controls concurrent lending of a digital copyrighted content item from the lender's terminal (or from the cache of said server 120) to the borrower's terminal, according to a number of available legitimate users' licenses of said copyrighted content item. For that, for example, server 120 determines a number of overall legitimate users' licenses (purchased by the lender) of said copyrighted content item that is stored (or provided from) said lender's terminal, and compares it with a number of the lent users' licenses. If said number of overall legitimate users' licenses is greater than said number of the lent users' licenses, then one or more users' licenses are still available for lending, and server 120 enables lending of said copyrighted content item accordingly. According to another embodiment of the present invention, software component 130, installed within said lender's terminal (and/or within the borrower's terminal), controls concurrent lending of said digital copyrighted content item by performing the above comparison. Thus, the control can be performed either by means of server 120 and/or by means of software components 130. According to still another embodiment of the present invention, when said copyrighted content item is lent, it is indicated within a corresponding table (or file), stored on the lender's terminal. Thus, instead of performing the above comparison, server 120 and/or software component accesses said table for determining whether there is one or more available users' licenses.

It should be noted that according to an embodiment of the present invention, a provider of server 120 and/or of software components 130 can receive royalties from each transaction. For example, if a copyrighted content item is lent for $10, said provider receives 50% of the transaction, i.e. $5. Alternatively, said provider can receive a fixed price per each transaction and/or per each predefined lending time unit (e.g., per a minute). Thus, for example, the system 100 provider can receive $4 per each transaction without considering the overall lending period of time.

Further, it should be noted that Web server 121, Data Streaming server 122 and Storage server 123 can be physically located on different (remote) servers.

In addition, according to an embodiment of the present invention, when receiving a request from a user to borrow a copyrighted content item, it is checked whether such copyrighted content item is already cached by means of Storage server 123 and is stored within it. Such check, for example, can be performed by comparing the file size and file type of the requested copyrighted content item with the same of the copyrighted content items stored within said Storage server 123. If it is determined that such copyrighted content item is already stored within said Storage server 123, then it can be provided to a borrower directly from said Storage server 123 without uploading it from lender's Web terminal.

FIG. 2B is a schematic illustration of basic characteristics (services) of software component 130, according to an embodiment of the present invention. Software component can provide Web connection from each user's terminal to server 120 (FIG. 1) for enabling lending copyrighted content items over data network 135 (FIG. 1). Also, software component 130 can determine copyrighted content items stored on each user's terminal, which are authorized by corresponding users for lending to other one or more users. For that, each user can store such copyrighted content items within a predefined folder that is “recognized” by software component 130 (e.g., a folder named as “Lending/Sharing”). Software component indexes such copyrighted content items and uploads their index to server 120. In addition, when a new copyrighted content item is uploaded to the terminal, corresponding software component 130 updates the items index of said terminal. The items index of each terminal can be updated, for example, once a day, twice a day, etc. The indexes of copyrighted content items from all users' terminals can be unified, giving rise to an overall items index. Such overall items index can also be stored within server 120. A user, wishing to borrow a copyrighted content item, by registering and logging in a predefined Web site can see, for example, which items can be lent from each terminal. The user can further search by means of said (overall) items index for a specific content item that he wishes to borrow. It should be noted that such a user can be requested to register within said predefined Web site over data network 135 before he borrows one or more copyrighted content items. After registering, the user can be further requested to download software component 130 and install it on his network terminal (e.g., cellular phone 110) to enable borrowing such content items.

Further, software component 130 can determine the copyrighting policy for lending such copyrighted content items, according to a number of legitimate (purchased) users' licenses. The copyrighting policy of each copyrighted content item can determined, for example, by analyzing the extension of said each copyrighted content item. For example, if the copyrighted content item is a song, then software component 130 can determine this by analyzing its (file) extension (e.g., “.wav”, “mp3” and the like), and then enables lending the file (content item) to another single user (since, usually, the song is purchased for a single user's license). During the time period when the song is lent, software component 130 prevents the lender from accessing it. Only when the lending time period is over and the borrower “returns” the rights for the song back to the lender, then the lender is allowed to listen to the song.

According to an embodiment of the present invention, each copyrighted content item to be lent can be indexed according to various parameters/metadata, such as a category, genre, name, file extension, lending time period, lending cost, number of legitimate users' licenses, number of available legitimate users' licenses, and the like. Thus, when a user surfs to a predefined Web site for borrowing a copyrighted content item, he is able to search for such content item (by means of items index) within, for example, a corresponding category or genre, to which said copyrighted content item is related.

According to an embodiment of the present invention, the (overall) items index can be edited, reorganized, ranked (e.g., creating a favorites songs or movies playlist), and the like by means of server 120 provider or by any other authorized party. Further, each user, whose items index was conveyed to said server 120 from his Web terminal, can edit his said items index (e.g., by surfing to a predefined Web site) and can edit other items indexes within said server 120, according to predefined authorizations.

According to another embodiment of the present invention, a digital copyrighted content item to be lent or shared within each user's terminal is checked by means of corresponding software component 130 for evaluating whether it is a legitimate content item or an illegal copy. Similarly, such a check can be performed by means of server 120, through which the copyrighted content item is streamed to the borrower's terminal.

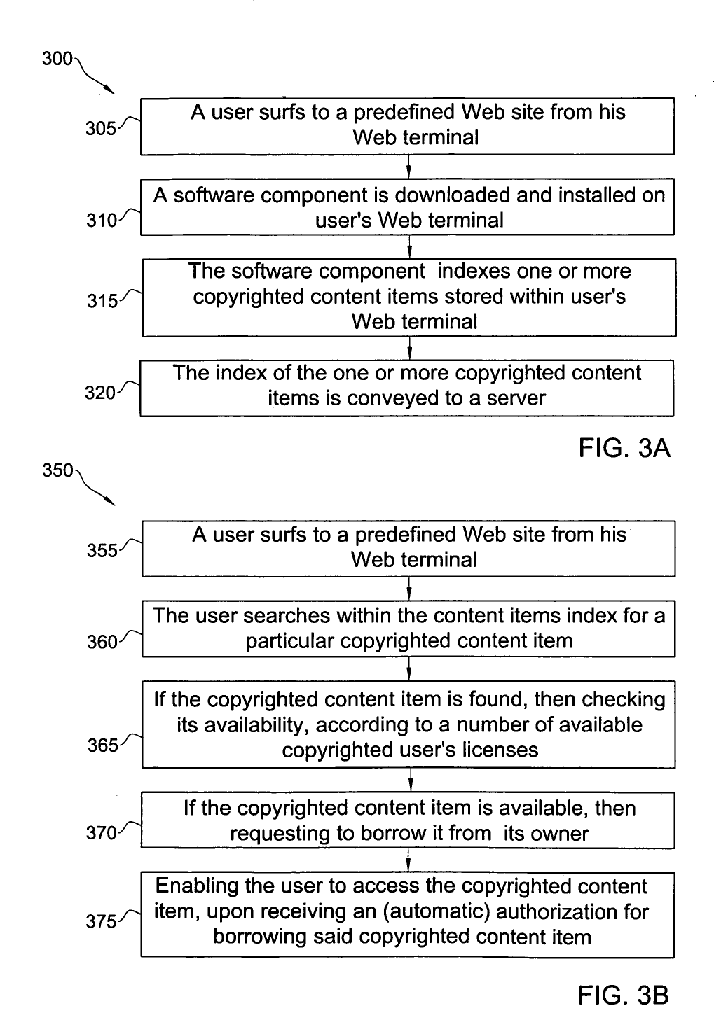

FIG. 3A is a flow-chart 300 of a method for enabling concurrent lending of digital copyrighted content items over a data network, according to an embodiment of the present invention. At step 305, a user wishing to lend a copyrighted content item from his Web terminal (e.g., personal computer 105′ (FIG. 1)) to one or more other users, surfs from said personal computer 105′ to a predefined Web site over data network 135 (FIG. 1), and then registers within said Web site. Such a Web site can be hosted, for example, by server 120 (FIG. 1). At step 310, software component 130 (FIG. 1) is downloaded from said Web site and installed on said personal computer 105′. Then, at step 315, software component 130 determines and indexes copyrighted content items stored on personal computer 105′, which are authorized by the user for lending. For that, the user can store such copyrighted content items within a predefined folder that is “recognized” by said software component 130 (e.g., a folder named “Lending/Sharing”). At step 320, the index of copyrighted content items of said personal computer 105′ is conveyed (e.g., uploaded) to server 120.

According to an embodiment of the present invention, each copyrighted content item to be lent can be indexed according to various parameters/metadata, such as a category, genre, name, file extension, lending time period, lending cost, number of legitimate users' licenses, and the like. Thus, when a user surfs to a predefined Web site for borrowing a copyrighted content item, he is able to search for such a content item (by means of items index) within, for example, a corresponding category or genre, to which said copyrighted content item is related.

FIG. 3B is a flow-chart 350 of a method for borrowing digital copyrighted content items over a data network, according to an embodiment of the present invention. At step 355, a user wishing to borrow a copyrighted content item, surfs from his Web terminal (e.g., cellular phone 110 (FIG. 1)) to a predefined Web site over data network 135 (FIG. 1). Such a Web site can be hosted, for example, by server 120 (FIG. 1). According to an embodiment of the present invention, the user registers within said Web site and/or downloads (e.g., from said Web site) and installs software component 130 on his cellular phone 110. At step 360, the user searches (requests) for a particular (predefined) copyrighted content item (e.g., the “Stronger” song of Britney Spears) by means of the index of copyrighted content items, that is stored on server 120. Such a particular copyrighted content item can be stored on one or more Web terminals over data network 135. If said copyrighted content item is found within said one or more Web terminals, then at step 365, the availability of said copyrighted content item is checked: whether it can be borrowed, or it is already concurrently lent to a maximal number of legitimate users, according to the number of purchased users' licenses. For that, for example, server 120 determines a number of overall legitimate users' licenses (purchased by the lender) of said copyrighted content item that is stored on (or provided from) lender's terminal, and compares it with a number of the lent said copyrighted content items (a number of the lent users' licenses of said copyrighted content item). If said number of overall legitimate users' licenses is greater than said number of the lent users' licenses, then one or more users' licenses are still available for lending, and server 120 enables lending of said copyrighted content item accordingly. According to another embodiment of the present invention, the above comparison is performed by means of software component 130, installed within said lender's terminal. According to still another embodiment of the present invention, when said copyrighted content item is lent, it is indicated within a corresponding table (or file), stored on lender's terminal.

Thus, instead of performing the above comparison, server 120 and/or software component accesses said table for determining whether there is one or more available users' licenses.

If the item is available for lending, then the user requests borrowing said item from its owner at step 370. Then, the owner of said copyrighted content item receives the request via server 120, and authorizes it. It should be noted that according to an embodiment of the present invention, all requests are processed and authorized automatically, and do not require intervention of the copyrighted content item owner. After that, at step 375, software component 130 installed within Web terminal of the copyrighted content item owner (e.g., within personal computer 105′ (FIG. 1)) starts streaming the copyrighted content item from said personal computer 105′ to said cellular phone 110, thereby enabling access to the requested copyrighted content item. It should be noted that the copyrighted content item can be streamed to cellular phone 110 via server 120, or directly from personal computer 105′ to cellular phone 110. Thus, according to an embodiment of the present invention, the user of cellular phone 110 starts using (listening, playing, watching and the like) the content of the copyrighted content item (e.g., song, video film, game, etc.) in real-time. During the time period when the copyrighted content item is lent, the lender (content item owner) is not allowed to use the content of said copyrighted content item, and he cannot play/activate the item (file) until the lending time period is over and until the borrower “returns” the rights for the lent copyrighted content item back to the lender. For that, an access of said lender to the lent copyrighted content item is denied by means of software component 130 installed on his Web terminal.

According to another embodiment of the present invention, if more than one user's license is available for said particular copyrighted content item (e.g., the copyrighted content item is a software application, such as the “Babylon®” dictionary), then such an item can be lent by the content item owner to more than one other user, according to a number of purchased (legally obtained) legitimate users' licenses. For example, if the user has purchased five users licenses, then he can share it with other four users and/or he can lend his fifth user's license to a fifth user.

It should be noted that according to still another embodiment of the present invention, system 100 can function without server 120, by communicating from one user's terminal to another by means of software component(s) 130, installed on said users' terminals.

According to a further embodiment of the present invention, instead of streaming the copyrighted content item to the designated user's terminal, said copyrighted content item can be downloaded to said user's terminal through server 120. After downloading the copyrighted content item, the borrower can use its content for a predefined period of time (e.g., 1 week), and then an access to said item is automatically denied by corresponding software component 130 that is installed on the borrower's terminal.

According to still further embodiment of the present invention, the user, after playing the copyrighted content item (e.g., watching a video film) that was streamed (or downloaded) to his terminal, can play back the content item again upon request.

It should be noted that according to an embodiment of the present invention, a program storage device readable by machine, tangibly embodying a program of instructions executable by the machine is configured to perform methods of the present invention, according to FIGS. 1 to 3B.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A method of enabling, concurrently lending at least one digital copyrighted content item from one user's terminal to a certain number of other users' terminals over a data network, according to a number of copyright users' licenses of each of said at least one digital copyrighted content item, said method comprising:
a) indexing at least one digital copyrighted content item provided from at least one user's terminal over a data network, giving rise to an items index;
b) receiving a request to lend a digital copyrighted content item to user's terminal over said data network;
c) conducting a search for the requested digital copyrighted content item by means of said items index;
d) if said requested digital copyrighted content item is found by means of said items index, checking whether it is available for lending to said user's terminal, according to a number of available copyright users' licenses of said requested digital copyrighted content item;
e) if said requested digital copyrighted content item is available for lending, then enabling lending it to said user's terminal; and
f) upon receiving another request to lend said digital copyrighted content item, repeating steps ‘d’ and ‘e’, and enabling concurrently lending said copyrighted content item to a certain number of users' terminals until said certain number does not exceed said number of available copyright users' licenses of said digital copyrighted content item.

2. The method according to claim 1, further comprising conveying a software component to user's terminal for indexing the at least one copyrighted content item to be lent from said user's terminal.

3. The method according to claim 1, further comprising comparing a number of lent digital copyrighted content items with a number of overall copyright users' licenses of said digital copyrighted content item for determining whether said digital copyrighted content item is available for lending.

4. The method according to claim 1, further comprising indicating the number of overall or available copyright users' licenses within the items index.

5. The method according to claim 1, further comprising indicating the metadata of each content item within the items index.

6. The method according to claim 1, further comprising providing a server within the data network for interconnecting users' terminals over said data network and enabling concurrent lending of the at least one digital copyrighted content item from one user's terminal, from which it is provided, to the certain number of other users' terminals, according to a number of legitimate copyright users' licenses of said digital copyrighted content item.

7. The method according to claim 1, further comprising conveying the items index from the at least one user's terminal to the server.

8. The method according to claim 1, further comprising surfing to a predetermined Web site for searching for the particular copyrighted content item.

9. The method according to claim 1, further comprising streaming the copyrighted content item from the at least one user's terminal.

10. The method according to claim 6, further comprising configuring the server with at least one of the following:
a) a web server for hosting at least one web site, and for enabling users' terminals to connect to said at least one web site;
b) a data streaming server for enabling streaming the at least one digital copyrighted content item to the certain number of other users' terminals; and
c) a storage server for storing the at least one digital copyrighted content item and/or its corresponding index, said at least one digital copyrighted content item to be lent to said certain number of other users' terminals.

11. The method according to claim 6, further comprising controlling lending the requested digital copyrighted content item by means of the server.

12. The method according to claim 2, further comprising controlling lending the requested digital copyrighted content item by means of the software component.

13. The method according to claim 9, further comprising streaming the digital copyrighted content item substantially in real-time.

14. The method according to claim 10, further comprising streaming the digital copyrighted content item substantially in real-time.

15. The method according to claim 6, further comprising caching the at least one digital copyrighted content item by means of the server.

16. The method according to claim 15, further comprising streaming the cached digital copyrighted content item from the server to the at least one user's terminal.

17. The method according to claim 10, further comprising uploading the at least one digital copyrighted content item to the server, prior to streaming it to the certain number of users' terminals.

18. The method according to claim 1, further comprising registering within a Web site for lending or borrowing the at least one copyrighted content item.

19. The method according to claim 1, further comprising sending a request for borrowing the at least one copyrighted content item to the at least one user's terminal, by which said copyrighted content item is provided.

20. The method according to claim 1, further comprising lending the copyrighted content item for a predefined period of time.

21. The method according to claim 1, further comprising disallowing the user that lent the copyrighted content item to access said copyrighted content item until the lending period is over.

22. The method according to claim 1, further comprising disallowing the user, to which the copyrighted content item is lent to access said copyrighted content item after the lending period is over.

23. The method according to claim 1, further comprising enabling the user that borrows the copyrighted content item to make a payment for borrowing said copyrighted content item.

24. The method according to claim 1, further comprising downloading the copyrighted content item to the terminal of the user, to which it is lent.

25. A method of enabling concurrently lending at least one digital copyrighted content item from a server to a certain number of users' terminals over a data network, according to a number of copyright users' licenses of each of said at least one digital copyrighted content item, said method comprising:
a) storing at least one digital copyrighted content item and its corresponding index within a server, giving rise to an items index;
b) receiving a request to lend a digital copyrighted content item to user's terminal over said data network;
c) conducting a search for the requested digital copyrighted content item by means of said items index;
d) if said requested digital copyrighted content item is found by means of said items index, checking whether it is available for lending to said user's terminal, according to a number of available copyright users' licenses of said requested digital copyrighted content item;
e) if said requested digital copyrighted content item is available for lending, then enabling lending it from said server to said user's terminal; and
f) upon receiving another request to lend said digital copyrighted content item, repeating steps ‘d’ and ‘e’, and enabling concurrently lending said copyrighted content item to a certain number of users' terminals until said certain number does not exceed said number of available copyright users' licenses of said digital copyrighted content item.

26. The method according to claim 25, further comprising comparing a number of lent digital copyrighted content items with a number of overall copyright users' licenses of said digital copyrighted content item for determining whether said digital copyrighted content item is available for lending.

27. The method according to claim 25, further comprising indicating the number of overall or available copyright users' licenses within the items index.

28. The method according to claim 25, further comprising indicating the metadata of each content item within the items index.

29. The method according to claim 25, further comprising surfing to a predetermined Web site for searching for the particular copyrighted content item.

30. The method according to claim 25, further comprising configuring the server with at least one of the following:
a) a web server for hosting at least one web site, and for enabling users' terminals to connect to said at least one web site;
b) a data streaming server for enabling streaming the at least one digital copyrighted content item to the certain number of other users' terminals; and
c) a storage server for storing the at least one digital copyrighted content item and/or its corresponding index, said at least one digital copyrighted content item to be lent to said certain number of other users' terminals.

31. The method according to claim 25, further comprising caching the at least one digital copyrighted content item by means of the server.

32. The method according to claim 31, further comprising streaming the cached digital copyrighted content item from the server to the at least one user's terminal.

33. The method according to claim 25, further comprising registering within a Web site for lending or borrowing the at least one copyrighted content item.

34. The method according to claim 25, further comprising lending the copyrighted content item for a predefined period of time.

35. The method according to claim 25, further comprising disallowing the user, to which the copyrighted content item is lent to access said copyrighted content item after the lending period is over.

36. The method according to claim 25, further comprising enabling the user that borrows the copyrighted content item to make a payment for borrowing said copyrighted content item.

37. The method according to claim 25, further comprising downloading the copyrighted content item to the terminal of the user, to which it is lent.

38. The method according to claim 30, further comprising streaming the digital copyrighted content item substantially in real-time.

39. The method according to claim 30, further comprising uploading the at least one digital copyrighted content item to the server, prior to streaming it to the certain number of users' terminals.

40. A server capable of enabling concurrently lending a digital copyrighted content item from one user's terminal to a certain number of other users' terminals according a number of legitimate copyright users' licenses of said digital copyrighted content item, said server comprising means configured to:
a) interconnect at least two users' terminals over a data network;
b) obtain an index of at least one digital copyrighted content item provided from at least one of said at least two users' terminals; and
c) enable concurrent lending of the digital copyrighted content item, indicated by means of said index, from said at least one user's terminal to a certain number of other users' terminals over said data network according a number of legitimate copyright users' licenses of said digital copyrighted content item.

41. A server capable of enabling concurrently lending a digital copyrighted content item over a data network to a certain number of other users' terminals according a number of legitimate copyright users' licenses of said digital copyrighted content item, said server comprising means configured to:
a) store at least one digital copyrighted content item and its corresponding index, giving rise to an items index; and
b) enable concurrent lending of the digital copyrighted content item, indicated by means of said items index, from said server to a certain number of other users' terminals over said data network according a number of legitimate copyright users' licenses of said digital copyrighted content item.

42. The server according to claim 40, wherein the digital copyrighted content item is streamed from one user's terminal to another user's terminal.

43. The server according to claim 40, wherein the digital copyrighted content item is streamed from the at least one user's terminal to said server.

44. The server according to claim 40, wherein the digital copyrighted content item is streamed from said server to the user's terminal.

45. The server according to claim 41, wherein the digital copyrighted content item is streamed from said server to the user's terminal.

46. The server according to any of claims 42, 43, 44 or 45, wherein the digital copyrighted content item is streamed substantially in real-time.

47. A system configured to enable concurrently lending digital copyrighted content items over a data network from one user's terminal to a certain number of other users' terminals according a number of copyright users' licenses of each digital copyrighted content item, said system comprising:
a) at least two users' terminals connected to a data network, wherein at least one of said at least two users' terminals provides a digital copyrighted content item to be lent to at least one another user's terminal; and
b) a server connected to said data network, said server interconnecting said at least two users' terminals and enabling concurrently lending said digital copyrighted content item from said at least one user's terminal to a certain number of other users' terminals according a number of copyright users' licenses of said digital copyrighted content item.

48. The system according to claim 47, wherein the server is configured by means of at least one of the following:
a) a web server for hosting at least one web site, and for enabling users' terminals to connect to said at least one web site;
b) a data streaming server for enabling streaming the at least one digital copyrighted content item from to the certain number of users' terminals; and
c) a storage server for storing the at least one digital copyrighted content item and/or its corresponding index, said at least one digital copyrighted content item to be lent to said certain number of other users' terminals.

49. The system according to claim 47, wherein the copyrighted content item is streamed to the at least one user's terminal.

50. The system according to claim 49, wherein the streaming occurs substantially in real-time.

51. The system according to claim 47, wherein the at least one digital copyrighted content item is cached within the server.

52. The system according to claim 51, wherein the cached digital copyrighted content item is streamed from the server to the at least one user's terminal.

53. The system according to claim 48, wherein the at least one digital copyrighted content item is uploaded to the server, prior to streaming it to the certain number of users' terminals.

54. The system according to claim 47, wherein a software component is installed on the user's terminal for indexing one or more copyrighted content items provided from said user's terminal, giving rise to an items index.

55. The system according to claim 54, wherein the items index is provided to the server.

56. The system according to claim 54, wherein the items index from users' terminals is unified within the server, giving rise to an overall items index.

57. The system according to claim 56, wherein the user searches within the items index or within the overall items index, looking for a particular copyrighted content item, which he wishes to borrow.

58. The system according to claim 47, wherein the lending of the requested digital copyrighted content item is controlled by means of the server.

59. The system according to claim 54, wherein the lending of the requested digital copyrighted content item is controlled by means of the software component.

60. The system according to claim 47, wherein the user registers within a Web site for lending or borrowing the at least one copyrighted content item.

61. The system according to claim 47, wherein the user sends a request for borrowing the copyrighted content item to the at least one user's terminal, by which said copyrighted content item is provided.

62. The system according to claim 47, wherein the user lends the copyrighted content item for a predefined period of time.

63. The system according to claim 47, wherein the user that lent the copyrighted content item is disallowed to access said copyrighted content item until the lending period is over.

64. The system according to claim 47, wherein the user, to which the copyrighted content item is lent, is disallowed to access said copyrighted content item after the lending period is over.

65. The system according to claim 47, wherein the user that borrows the copyrighted content item makes a payment for borrowing said copyrighted content item.

66. The system according to claim 47, wherein the copyrighted content item is downloaded to the terminal of the user, to which it is lent.

67. The system according to claim 47, wherein a number of lent digital copyrighted content items is compared with a number of overall copyright users' licenses of said digital copyrighted content item for determining whether said digital copyrighted content item is available for lending.

68. The system according to claim 54, wherein the number of overall or available copyright users' licenses is indicated within the items index.

69. The system according to claim 54, wherein the metadata of each content item is indicated within the items index.

70. A system configured to enable concurrently lending digital copyrighted content items over a data network to a certain number of users' terminals according a number of copyright users' licenses of each digital copyrighted content item, said system comprising:
a) at least two users' terminals connected to a data network; and
b) a server connected to said data network, said server storing at least one copyrighted content item and its corresponding index, giving rise to items index, and enabling concurrently lending said digital copyrighted content item to a certain number of users' terminals according a number of copyright users' licenses of said digital copyrighted content item.

71. The system according to claim 70, wherein the server is configured by means of at least one of the following:
a) a web server for hosting at least one web site, and for enabling users' terminals to connect to said at least one web site;
b) a data streaming server for enabling streaming the at least one digital copyrighted content item from to the certain number of users' terminals; and
c) a storage server for storing the at least one digital copyrighted content item and/or its corresponding index, said at least one digital copyrighted content item to be lent to said certain number of other users' terminals.

72. The system according to claim 70, wherein the copyrighted content item is streamed to the at least one user's terminal.

73. The system according to claim 72, wherein the streaming occurs substantially in real-time.

74. The system according to claim 71, wherein the at least one digital copyrighted content item is uploaded to the server, prior to streaming it to the certain number of users' terminals.

75. The system according to claim 70, wherein the lending of the requested digital copyrighted content item is controlled by means of the server.

76. The system according to claim 70, wherein the user registers within a Web site for lending or borrowing the at least one copyrighted content item.

77. The system according to claim 70, wherein the user lends the copyrighted content item for a predefined period of time.

78. The system according to claim 70, wherein the user, to which the copyrighted content item is lent, is disallowed to access said copyrighted content item after the lending period is over.

79. The system according to claim 70, wherein the user that borrows the copyrighted content item makes a payment for borrowing said copyrighted content item.

80. The system according to claim 70, wherein the copyrighted content item is downloaded to the terminal of the user, to which it is lent.

81. The system according to claim 70, wherein a number of lent digital copyrighted content items is compared with a number of overall copyright users' licenses of said digital copyrighted content item for determining whether said digital copyrighted content item is available for lending.

82. The system according to claim 70, wherein the number of overall or available copyright users' licenses is indicated within the items index.

83. The system according to claim 70, wherein the metadata of each content item is indicated within the items index.

84. A program storage device readable by machine, tangibly embodying a program of instructions executable by the machine to perform a method of enabling concurrently lending at least one digital copyrighted content item from one user's terminal to a certain number of other users' terminals over a data network, according to a number of copyright users' licenses of each of said at least one digital copyrighted content item, said method comprising:
a) indexing at least one digital copyrighted content item provided from at least one user's terminal over a data network, giving rise to an items index;
b) receiving a request to lend a digital copyrighted content item to user's terminal over said data network;
c) conducting a search for the requested digital copyrighted content item by means of said items index;
d) if said requested digital copyrighted content item is found by means of said items index, checking whether it is available for lending to said user's terminal, according to a number of available copyright users' licenses of said requested digital copyrighted content item;
e) if said requested digital copyrighted content item is available for lending, then enabling lending it to said user's terminal; and
f) upon receiving another request to lend said digital copyrighted content item, repeating steps ‘d’ and ‘e’, and enabling concurrently lending said copyrighted content item to a certain number of users' terminals until said certain number does not exceed said number of available copyright users' licenses of said digital copyrighted content item.

85. A program storage device readable by machine, tangibly embodying a program of instructions executable by the machine to perform a method of enabling concurrently lending at least one digital copyrighted content item from a server to a certain number of users' terminals over a data network, according to a number of copyright users' licenses of each of said at least one digital copyrighted content item, said method comprising:
a) storing at least one digital copyrighted content item and its corresponding index within a server, giving rise to an items index;
b) receiving a request to lend a digital copyrighted content item to user's terminal over said data network;
c) conducting a search for the requested digital copyrighted content item by means of said items index;
d) if said requested digital copyrighted content item is found by means of said items index, checking whether it is available for lending to said user's terminal, according to a number of available copyright users' licenses of said requested digital copyrighted content item;
e) if said requested digital copyrighted content item is available for lending, then enabling lending it from said server to said user's terminal; and
f) upon receiving another request to lend said digital copyrighted content item, repeating steps ‘d’ and ‘e’, and enabling concurrently lending said copyrighted content item to a certain number of users' terminals until said certain number does not exceed said number of available copyright users' licenses of said digital copyrighted content item.

86. The method according to claim 1, substantially as described and illustrated herein.

87. The method according to claim 25, substantially as described and illustrated herein.

88. The server according to claim 40, substantially as described and illustrated herein.

89. The server according to claim 41, substantially as described and illustrated herein.

90. The system according to claim 47, substantially as described and illustrated herein.

91. The system according to claim 70, substantially as described and illustrated herein.

92. The program storage device according to claim 84, substantially as described and illustrated herein.

93. The program storage device according to claim 85, substantially as described and illustrated herein.
